(19) United States
(12) Patent Application Publication
(10) Pub. No.: US 2026/0093320 A1
(43) Pub. Date: Apr. 2, 2026

(54) INFORMATION PROCESSING SYSTEM

(71) Applicant: HONDA MOTOR CO., LTD., Tokyo (JP)

(72) Inventors: Kenta Maruyama, Tokyo (JP); Junichiro Onaka, Tokyo (JP)

(21) Appl. No.: 19/311,006

(22) Filed: Aug. 27, 2025

(30) Foreign Application Priority Data
Sep. 30, 2024 (JP) 2024-171103

(51) Int. Cl. G06F 3/01; G06F 3/16

(52) U.S. Cl. CPC G06F 3/013; G06F 3/167

(57) ABSTRACT

An information processing system includes a first device mounted in a mobile object, a plurality of second devices used by a plurality of users at places other than the mobile object, an information acquisition part, a provision part, and a plurality of presentation parts. The information acquisition part acquires predetermined information transmitted by the first device. The provision part provides the predetermined information acquired by the information acquisition part to the plurality of second devices. The presentation parts present the predetermined information provided to the plurality of second devices by the provision part. When an operation input from a first user is performed using one second device of the plurality of second devices, the presentation parts of the second devices other than the one second device present an output result based on the operation input performed using the one second device.

### CROSS-REFERENCE TO RELATED APPLICATION

Priority is claimed on Japanese Patent Application No. 2024-171103, filed Sep. 30, 2024, the content of which is incorporated herein by reference.

### BACKGROUND OF THE INVENTION

Field of the Invention

The present invention relates to an information processing system.

### Description of Related Art

Recently, measures for providing access to a sustainable transportation system in consideration of persons in vulnerable situations such as aged persons, disabled persons, or children out of traffic participants have been actively taken. For the purpose of realization thereof, research and development for improving safety and convenience of traffic, particularly, through development of moving means dedicated for vulnerable road users has been focused on.

In this regard, a system configured to externally store a video by storing video data in an external server (a filing system) in a time series and to reproduce the video at any time is known (for example, see Patent Document 1 (Japanese Unexamined Patent Application, First Publication No. 2003-335197)).

### SUMMARY OF THE INVENTION

When simulation of riding on a mobile object (hereinafter referred to as “simulated riding”) is carried out using a device which is used at a place different from that of the mobile object, there is a problem in that a burden is imposed on a user who carries out simulated riding at a place different from that of the mobile object.

The present invention was made to solve the aforementioned problem, and an objective thereof is to allow a user located at a place different from that of a mobile object to carry out more appropriate simulated riding. Another objective thereof is to more contribute to development of a sustainable transportation system and support of good connection between an urban area and a local area such as the vicinity of the urban area.

An information processing system according to the present invention employs the following configurations.

(1) An information processing system according to an aspect of the present invention includes a first device mounted in a mobile object, a plurality of second devices used by a plurality of users at places other than the mobile object, an information acquisition part configured to acquire predetermined information transmitted by the first device, a provision part configured to provide the predetermined information acquired by the information acquisition part to the plurality of second devices, and a plurality of presentation parts configured to present the predetermined information provided to the plurality of second devices by the provision part, wherein, when an operation input from a first user is performed using one second device of the plurality of second devices, the presentation parts of the second devices other than the one second device present an output result based on the operation input performed using the one second device.

(2) The information processing system according to the aspect of (1) may further include a user information acquisition part configured to acquire user information of users of the second devices, and the second device used by the first user may further include a creation part configured to create an output signal for presenting the output result based on the user information acquired by the user information acquisition part.

(3) In the aspect of (1), each second device may include a line-of-sight detection part configured to detect a line-of-sight direction of a user, and the presentation part may present the output result based on the line-of-sight direction of the user detected by the line-of-sight detection part.

(4) In the aspect of (1), each second device may include a POI acquisition part configured to acquire point of interest (POI) information, the POI acquisition part may acquire POI information based on position information of the first device when the presentation part presents the output result, and the presentation part may present the POI information acquired by the POI acquisition part along with the output result.

(5) In the aspect of (3), each second device may include a POI acquisition part configured to acquire point of interest (POI) information, the POI acquisition part may acquire POI information based on the line-of-sight direction of the user detected by the line-of-sight detection part, and the presentation part may acquire a position at which the output result is to be presented based on the POI information acquired by the POI acquisition part.

(6) In the aspect of (1), each second device may include a POI acquisition part configured to acquire point of interest (POI) information and a selection part configured to select POI information closest to the mobile object out of a plurality of pieces of POI information when the plurality of pieces of POI information are acquired by the POI acquisition part, and the presentation part may present the POI information selected by the selection part to the second devices other than the one second device.

(7) In the aspect of (1), the presentation part may change a position at which the output result is to be presented based on a speed of the mobile object.

(8) The information processing system according to the aspect of (1) may further include a mobile object behavior detection part configured to detect right turn or left turn of the mobile object, and the presentation part may change details of the output result to be presented when right turn or left turn of the mobile object is detected by the mobile object behavior detection part after the output result has been presented.

(9) The information processing system according to the aspect of (1) may further include a creation part configured to create notification information including the output result to the first device based on the operation input performed on one second device out of the plurality of second devices when the operation input from a first user is performed using the one second device.

(10) The information processing system according to the aspect of (1) may further include an audio information acquisition part configured to acquire audio information based on audio from a user, and the presentation part may present the output result based on the operation input and the audio information.

(11) The information processing system according to the aspect of (4) may further include an audio information acquisition part configured to acquire audio information based on audio from a user, and the presentation part may present the POI information and the audio information acquired in association with the POI information by the audio information acquisition part along with the output result.

According to the aspects of (1) to (11), it is possible to allow a user located at a place different from that of a mobile object to carry out more appropriate simulated riding.

### BRIEF DESCRIPTION OF THE DRAWINGS

FIG. 1 is a diagram showing an operating environment or the like of an information processing system 1 and a management server 300.

FIG. 2 is a diagram showing an example of details of user data 360.

FIG. 3 is a diagram showing the configuration of a first device 100.

FIG. 4 is a diagram showing an example of arrangement of a part of the first device 100 in a mobile object M.

FIG. 5 is a diagram showing the configuration of a second device 200.

FIG. 6 is a diagram showing an image corresponding to a direction of orientation.

FIG. 7 is a diagram showing a first example of functional configurations of a first controller 170 and a second controller 270.

FIG. 8 is a diagram showing a second example of the functional configurations of the first controller 170 and the second controller 270.

FIG. 9 is a sequence diagram showing an example of a process flow that is performed by the information processing system 1.

FIG. 10 is a diagram showing an example of an image IM10 indicating inquiry information.

FIG. 11 is a diagram showing an example of an image IM20 indicating a request result.

FIG. 12A is a sequence diagram showing a first example of the process flow that is performed by the information processing system 1.

FIG. 12B is a sequence diagram showing a second example of the process flow that is performed by the information processing system 1.

FIG. 12C is a sequence diagram showing a third example of the process flow that is performed by the information processing system 1.

FIG. 13A is a diagram showing an example of provided information.

FIG. 13B is a diagram showing an example of provided information.

FIG. 13C is a diagram showing an example of provided information.

FIG. 14 is a diagram showing a third example of the functional configurations of the first controller 170 and the second controller 270.

FIG. 15A is a sequence diagram showing a fourth example of the process flow that is performed by the information processing system 1.

FIG. 15B is a sequence diagram showing a fifth example of the process flow that is performed by the information processing system 1.

FIG. 16 is a diagram showing an example of provided information.

### DETAILED DESCRIPTION OF THE INVENTION

Hereinafter, an information processing system according to an embodiment of the present invention will be described with reference to the accompanying drawings. In the following description, an information processing system to which an information processing device is applied will be described. The information processing system includes, for example, a first device that is mounted in a mobile object in which an occupant rides, a second device that is used by a user at a place different from that of the mobile object, and an information processing device. The mobile object is, for example, a vehicle and may be any mobile object (for example, a ship or a flying object) as long as an occupant can ride therein. The occupant is mainly a driver of the mobile object but may be an occupant other than the driver.

The first device and the second device get into a state in which a telephone call is made therebetween by transmitting audio collected by a microphone to a communication partner and causing a speaker to reproduce the audio. Mixed reality (MR) is provided to the second device by causing the second device to display a part of an image captured by a camera unit of the first device. Accordingly, a user of the second device can obtain a feeling as if the user were actually riding in the mobile object (simulated riding experience) while staying at a place different from that of the mobile object. The occupant can make a conversation with the user carrying out simulated riding in the mobile object via the first device and provide the user with a feeling as if the user were actually riding in the mobile object. Virtual reality (VR) may be provided to the second device by causing the second device to display a part of an image captured by the camera unit of the first device. Accordingly, the user of the second device can obtain a feeling as if the user were actually riding in the mobile object (simulated riding experience) while staying at a place different from that of the mobile object. The occupant can make a conversation with the user carrying out simulated riding in the mobile object via the first device and thus provide the user with a feeling as if the user were actually riding in the mobile object. The user can be fully concentrated on the world of a video to use an application. In the following description, simulated experience as if a user were actually riding in a mobile object may be referred to as “simulated riding” as described above. The first device and the second device do not need to have a one-to-one relation, and one of a plurality of first devices may match a plurality of second devices in a single-to-multiple relation to operate as an information processing system. In the latter, for example, one occupant can simultaneously or sequentially communicate with a plurality of users.

### Basic Configuration

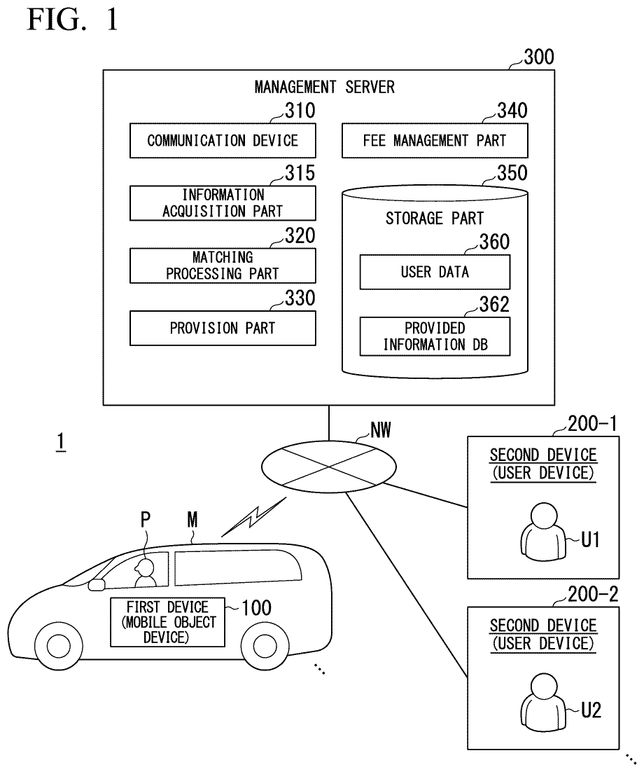

FIG. 1 is a diagram showing an operating environment or the like of an information processing system 1 and a management server 300. The information processing system 1 includes a first device (mobile object device) 100 that is mounted in a mobile object M in which a passenger P rides and a second device (user device) 200-1 that is used by a user U1 and a second device (user device) 200-2 that is used by a user U2 at places (from which an accidentally close place is not excluded) other than the mobile object M. The first device 100, the second device 200-1, the second device 200-2, and the management server 300 communicate with each other via a network NW. The information processing system 1 may or may not include the management server 300. In the following description, an arbitrary user of the user U1 and the user U2 is referred to as a user U. An arbitrary second device of the second device 200-1 and the second device 200-2 is referred to as a second device 200.

The network NW includes, for example, at least one of the Internet, a wide area network (WAN), a local area network (LAN), a mobile communication network, and a cellular network. The management server 300 is an example of an “information processing device. ” The management server 300 may be realized by a server device or a storage device which is assembled into a cloud computing system. In this case, the function of the management server 300 may be realized by a plurality of server devices or storage devices in the cloud computing system. The first device 100 that is mounted in the mobile object M may be realized by a plurality of units.

The management server 300 manages information provided to the first device 100 and the second device 200 or performs management for communication. The management server 300 includes, for example, a communication device 310, an information acquisition part 315, a matching processing part 320, a provision part 330, a fee management part 340, and a storage part 350. The information acquisition part 315, the matching processing part 320, the provision part 330, and the fee management part 340 are realized, for example, by causing a hardware processor such as a central processing unit (CPU) to execute a program (software).

Some or all of these constituents may be realized by hardware (a circuit part including circuitry) such as a large scale integration (LSI) circuit, an application-specific integrated circuit (ASIC), a field-programmable gate array (FPGA), or a graphics processing unit (GPU) or may be cooperatively realized by software and hardware. The program may be stored in a storage device (a storage device including a non-transitory storage medium) such as a hard disk drive (HDD) or a flash memory in advance or may be stored in a removable storage medium (a non-transitory storage medium) such as a DVD or a CD-ROM and installed by setting the storage medium into a drive device. The program may be stored in the management server 300 and may be appropriately updated through connection to the network NW.

The communication device 310 is a communication interface for connection to the network NW. Communication between the communication device 310 and the first device 100 and communication between the communication device 310 and the second device 200 are performed, for example, based on a transmission control protocol/Internet protocol (TCP/IP).

The information acquisition part 315 acquires various types of information transmitted by the first device 100, the second device 200, and other external devices via the network NW. Various types of information may include video data, audio data of a driver, and vehicle data (display details on a meter or an in-vehicle infotainment (IVI) system).

The matching processing part 320 is realized, for example, by causing a processor such as a CPU to execute a program (an instruction group) stored in a storage medium. For example, the matching processing part 320 performs matching between a user U and a passenger P to be matched with reference to user data 360, for example, when the communication device 310 receives a matching request from the user U via the second device 200 or from the passenger P via the first device 100. The matching processing part 320 transmits communication identifying information of the first device 100 of the passenger P to the second device 200 of the matched user U and transmits communication identifying information of the second device 200 of the user U to the first device 100 of the matched passenger P, using the communication device 310. The first device 100 and the second device 200 having received the communication identifying information can communicate with better real-time characteristics which are suitable, for example, for a user datagram protocol (UDP).

The provision part 330 generates information to be provided to the first device 100 and the second device 200 based on various types of information acquired by the information acquisition part 315 and transmits the generated information to target devices. The provision part 330 generates information indicating a process result from the matching processing part 320 or fee information (payment information) managed by the fee management part 340 and provides the generated information to the target devices.

The fee management part 340 manages a fee to be charged for the user U according to the information provided to the user U or a fee to be charged for the passenger P according to the information provided to the passenger P of the mobile object M. For example, the fee management part 340 may manage rewards to be paid for the user U or the passenger P according to provision of information from the user U or the passenger P. The fee management part 340 may perform a process associated with payment of the user U and the passenger P.

The storage part 350 may be realized by the aforementioned various storage devices or a solid state drive (SSD), an electrically erasable programmable read only memory (EEPROM), a read only memory (ROM), a random access memory (RAM), or the like. For example, user data 360, a provided information DB 362, programs, and various types of other information can be stored in the storage part 350.

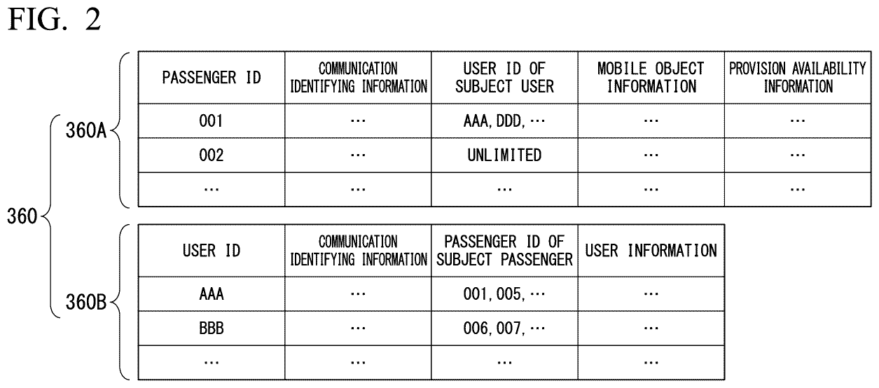

FIG. 2 is a diagram showing an example of details of user data 360. The user data 360 includes an occupant list 360A and a user list 360B. In the occupant list 360A, for example, an occupant ID which is identification information of a passenger P of the mobile object M, communication identifying information (such as an IP address) thereof, a user ID which is identification information of the user U to be matched, information of a mobile object in which an occupant rides, and provision availability information set by the occupant are correlated with each other. The mobile object information includes, for example, information of equipment (onboard equipment information) mounted in the mobile object M or vehicle physique information indicating a size or an outer shape of the mobile object M. The mobile object information may include information on a current position or a destination of the mobile object M and a surrounding situation (for example, traveling on a seashore road) thereof which is periodically transmitted from the mobile object M in a predetermined period.

In the user list 360B, for example, a user ID, communication identifying information (such as an IP address) thereof, and information on a passenger P and a user to be matched are correlated with each other. The user information may include information on a physique (for example, a height or a sitting height) and information (for example, age) for predicting the physique. The provision availability information is information which can be provided by the mobile object M or information which cannot be provided by the mobile object M and is set, for example, by the passenger P. The provision availability information may be set for each onboard equipment in the mobile object M or may be set for each user U. Examples of the provision availability information include “provision of image is permitted,” “provision of audio is not permitted,” “provision of indoor image is permitted but provision of outdoor image is not permitted,” “provision of occupant image is not permitted,” and “use of navigation device is not permitted,” and the provision availability information is not limited thereto. The provision availability information may include a fee for permitting provision (a service provision fee). The user data 360 is not limited to the mode shown in FIG. 2 and may be generated in any mode as long as it includes the aforementioned information.

Various types of information to be provided to a user U or a passenger P are stored in the provided information DB 362. The various types of information include, for example, map information, point of interest (POI) information and an image (for example, a computer graphics (CG) image of a person or the like or an image such as a mark, a sign, or an icon) drawn through computer processing. The POI information is, for example, information on various stores, theme parks, and ground objects for each point and may be included in map information. The various types of information may include audio information. The provided information DB 362 may include advertisement information. The advertisement information may include, for example, an advertisement for the mobile object M, an advertisement for the user U or the passenger P, and an advertisement for products or services of stores. The inserted advertisement information may be managed separately from indoor or outdoor information and may be different from advertisement information which is inserted at the time of transmission in real time when the advertisement information is archived and transmitted later (for example, closed stores may be replaced with newest ones and menus to be introduced may be replaced with newest ones). The advertisement information is, for example, a moving image or an audio.

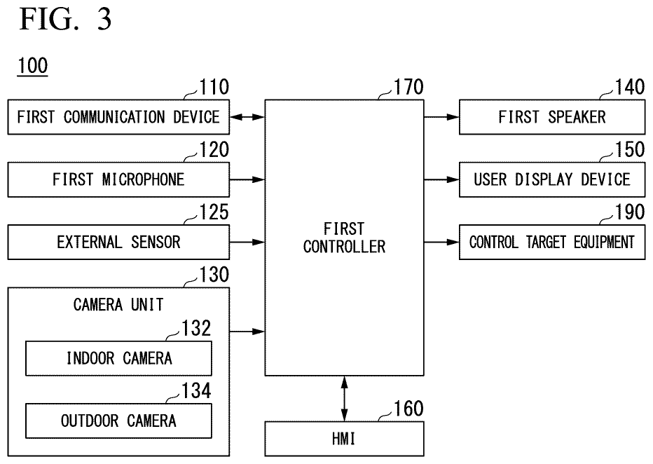

FIG. 3 is a diagram showing a configuration of the first device 100. The first device 100 includes, for example, a first communication device 110, a first microphone 120, an external sensor 125, a camera unit 130, a first speaker 140, a user display device 150, a human-machine interface (HMI) 160, and a first controller 170. The first controller 170 is connected to control target equipment 190 mounted in the mobile object M.

The first communication device 110 is a communication interface that is used to communicate with a communication device 310 of the management server 300 and a second communication device 210 of the second device 200 which will be described later via the network NW.

The first microphone 120 collects at least an audio uttered by the passenger P. The first microphone 120 may be provided inside of the mobile object M and have sensitivity with which an audio outside of the mobile object M can be collected. The first microphone 120 may include a microphone that is provided inside of the mobile object M and a microphone that is provided outside of the mobile object M. In the following description, audio information acquired by the microphone provided indoor may be referred to as “indoor audio information.” For example, the audio collected by the first microphone 120 is transmitted to the management server 300 or the second device 200 via the first controller 170 by the first communication device 110. When the microphone provided outside of the mobile object M cannot be set, indoor audio information may be processed to simulate and generate outdoor audio information based on traveling information (such as a vehicle speed, an acceleration or deceleration, or road vibration) or a surrounding traveling environment. A positional relationship of an utterer with respect to the mobile object M (whether the utterer is located inside or outside) may be able to be recorded, and the collected audio may be processed according to the positional relationship.

The external sensor 125 detects the position of an object near the mobile object M. The external sensor 125 includes, for example, a radar device, a Light Detection and Ranging (LIDAR) sensor, and various types of other proximity sensors. The radar device detects at least a position (a distance and a direction) of an object by radiating radio waves such as millimeter waves to the surroundings of the mobile object M and detecting radio waves (reflected waves) reflected by the object. The radar device may detect the position and the speed of an object using a frequency modulated continuous wave (FM-CW) system. The LIDAR sensor radiates light (or electromagnetic waves of wavelengths close to light) to the surroundings of the mobile object M, measures scattered light thereof, and detects a distance to an object based on a time period from emission of light to reception of light. The light to be radiated is, for example, a pulse-shaped laser beam. The radar device or the LIDAR sensor is attached to an arbitrary position on the mobile object M. The external sensor 125 may detect nearby object using an image captured by an outdoor camera 134 of the camera unit 130.

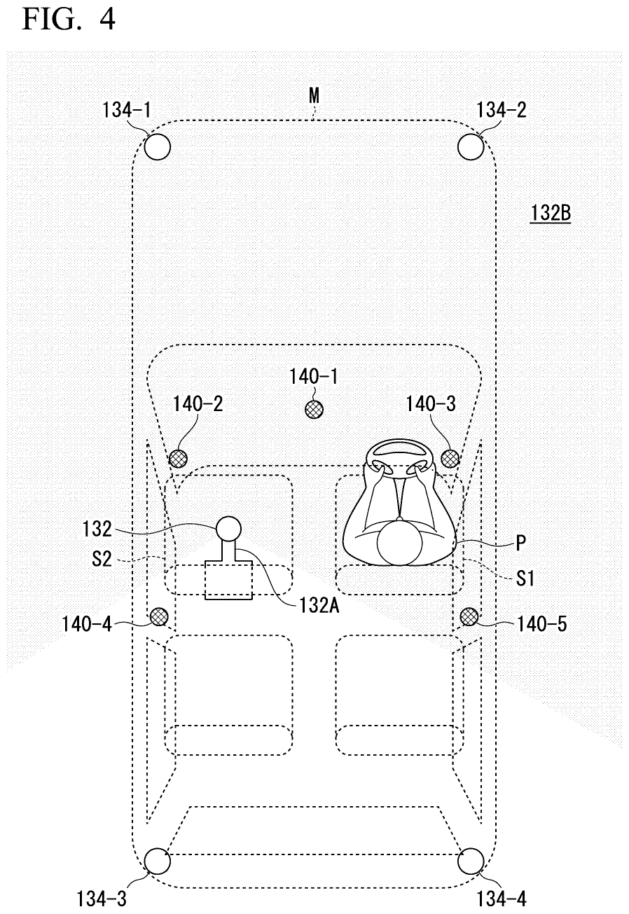

The camera unit 130 includes, for example, an indoor camera 132 and an outdoor camera 134. The first speaker 140 outputs an audio uttered by the user U and acquired via the first communication device 110. Details of the camera unit 130, arrangement of the first speaker 140, and the like will be described later with reference to FIG. 4.

The user display device 150 virtually displays the user U as if the user U were inside of the mobile object M. For example, the user display device 150 displays a hologram or displays the user U in a part corresponding to a mirror or a windshield of the mobile object M.

The HMI 160 includes a touch panel or an audio response unit (an agent device). The HMI 160 receives various instructions from the passenger P to the first device 100 or provides various types of information to the passenger P.

For example, the first controller 170 includes a processor such as a CPU and a storage medium connected to the processor and stored in a program (an instruction group) and controls the constituents of the first device 100 by causing the processor to execute the instruction group.

The control target equipment 190 is, for example, a navigation device mounted in the mobile object M and used to guide a route to a destination or onboard equipment such as a driving support device that controls one or both of steering and a speed of the mobile object M to support driving of the occupant P. The control target equipment 190 includes, for example, a seat drive device that can adjust the position (a longitudinal or lateral position), the direction, and the height of a seat. When a video is seen by the second device 200 and the camera unit 130 of the first device 100 is attached to the seat, an influence on the video can be curbed by prohibiting movement of the seat. It may be possible to cope with a case in which movement of the seat is permitted by performing a process such as viewing angle change such that an influence of movement of the seat on the video is curbed. When the user U intends to see a video outside of the current viewing angle of the camera unit 130, the seat drive device may be controlled in response to a request from the second device 200.

FIG. 4 is a diagram showing an example of arrangement of a part of the first device 100 in the mobile object M. The indoor camera 132 is attached to, for example, a neck pillow of a passenger's seat S2 (an example of a “predetermined seat”) using an attachment 132A and is provided at a position which is slightly separated in the traveling direction of the mobile object M from a backrest of the passenger's seat S2. The indoor camera 132 includes a wide-angle lens and can image a range indicated by a hatched area 132B in the drawing. The indoor camera 132 can also image the outside through a windshield as well as the inside of the mobile object M. In the following description, the passenger's seat S2 is a predetermined seat, but the predetermined seat may be another seat such as a rear seat.

The outdoor camera 134 includes, for example, a plurality of child outdoor cameras 134-1 to 134-4. By combining images captured by the plurality of child outdoor cameras 134-1 to 134-4, an image such as a panoramic image which is obtained by imaging the outside of the mobile object M is obtained. The outdoor camera 134 may include a wide-angle camera provided on the roof of the mobile object M instead thereof (or in addition thereto). A camera that can image the rear view of the passenger's seat S2 may be added to the indoor camera 132. A mobile object image which will be described later may be generated as a panoramic image of 360 degrees by the first controller 170 by combining images captured by one or more indoor cameras 132 or may be generated as a panoramic image of 360 degrees by the first controller 170 by appropriately combining an image captured by the indoor camera 132 and an image captured by the outdoor camera 134.

The first speaker 140 outputs an audio of the user U acquired via the first communication device 110. The first speaker 140 includes, for example, a plurality of child first speakers 140-1 to 140-5. For example, the child first speaker 140-1 is disposed at the center of an instrument panel. The child first speaker 140-2 is disposed at a left end of the instrument panel. The child first speaker 140-3 is disposed at a right end of the instrument panel. The child first speaker 140-4 is disposed in a lower part of a left door. The child first speaker 140-5 is disposed in a lower part of a right door. When the audio of the user U is output from the first speaker 140, the first controller 170 localizes a sound image such that the audio can be heard from the passenger's seat S2 by the occupant P sitting on a driver's seat S1, for example, by outputting the audio with the same sound volume from the child first speaker 140-2 and the child first speaker 140-4 and turning off the other child first speakers. The sound image localization method is not limited to adjustment of the sound volume and may be performed by making phases of sound output from the child first speakers different from each other. For example, when a sound image is localized such that the audio is heard from the left side, the timing at which the audio is output from the child first speaker on the left side is set to be slightly earlier than the timing at which the same audio is output from the child first speaker on the right side.

When the audio of the user U is output from the first speaker 140, the first controller 170 may localize a sound image such that the audio is heard from a height corresponding to the head height of the user U sitting on the passenger's seat S2 by the passenger P and cause the first speaker 140 to output the audio uttered by the user 140. In this case, the first speaker 140 has to include a plurality of child first speakers 140-k (where k is two or more natural numbers) with different heights.

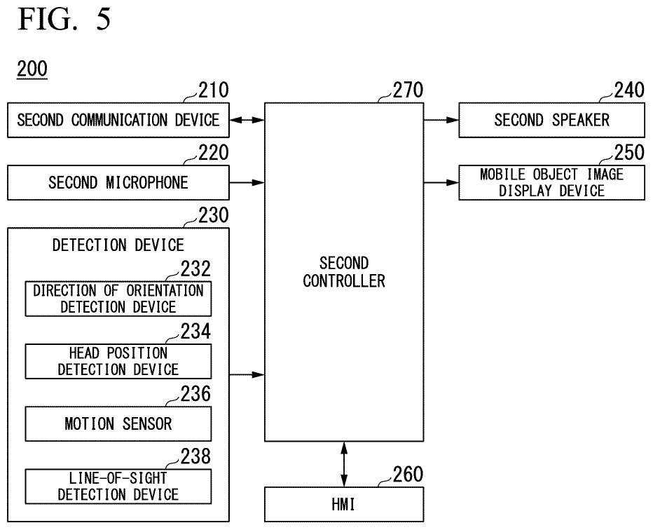

FIG. 5 is a diagram showing a configuration of the second device 200. The second device 200 includes, for example, a second communication device 210, a second microphone 220, a detection device 230, a second speaker 240, a mobile object image display device 250, an HMI 260, and a second controller 270. The detection device 230 includes, for example, a direction-of-orientation detection device 232, a head position detection device 234, a motion sensor 236, and a line-of-sight detection device 238.

The second communication device 210 is a communication interface that is used to communicate with the communication device 310 of the management server 300 and the first communication device 110 of the first device 100 via the network NW.

The second microphone 220 collects an audio uttered by the user U. The audio collected by the second microphone 220 is transmitted to the first communication device 110 via the second controller 270 by the second communication device 210.

The direction-of-orientation detection device 232 is a device that detects a direction of orientation. The direction of orientation is a direction based on a face direction or a line-of-sight direction of the user U or both thereof. In the following description, the direction of orientation is defined as an angle in a horizontal plane, that is, an angle not including a component in a vertical direction, but the direction of orientation may be an angle also including a component in the vertical direction. The direction-of-orientation detection device 232 may include a physical sensor (for example, an acceleration sensor or a gyro sensor) attached to a VR goggle which will be described later or may be an infrared sensor that detects a plurality of positions of the head of the user U or a camera imaging the head of the user U. In any case, the second controller 270 calculates the direction of orientation based on information input from the direction-of-orientation detection device 232. Various techniques for this are known, and thus detailed description thereof will be omitted.

The head position detection device 234 is a device that detects a position (height) of the head of the user U. For example, one or more infrared sensors or optical sensors provided around a seat on which the user U sits are used as the head position detection device 234. In this case, the second controller 270 detects the position of the head of the user U based on whether there is a detection signal from the one or more infrared sensors or optical sensors. The head position detection device 234 may be an acceleration sensor attached to a VR goggle. In this case, the second controller 270 detects the position of the head of the user U by integrating a value obtained by subtracting the gravitational acceleration from the output of the acceleration sensor. Information of the position of the head acquired in this way is provided as height information to the second controller 270. The position of the head of the user may be acquired based on an operation of the user U on the HMI 260. For example, the user U may input the stature in numerals to the HMI 260 or may input the stature using a dial switch included in the HMI 260. In this case, the position of the head, that is, the height information, is calculated from the stature. The user U may input discrete values such as Large/middle/small of the physique instead of a continuous value in the HMI 260. In this case, the height information is acquired based on the information indicating the physique. The height of the head of the user is not particularly acquired, but the height of the head of the user U may be acquired simply based on the physique of a general adult (by male/female).

The motion sensor 236 is a device that is used to recognize a gesture operation which is performed by the user U. For example, a camera that images the upper half of the user U is used as the motion sensor 236. In this case, the second controller extracts feature points (a fingertip, a wrist, an elbow) of the body of the user U from an image captured by the camera and recognizes the gesture operation of the user U based on movement of the feature points.

The line-of-sight detection device 238 is a device that detects a line of sight. The line of sight is a line-of-sight direction of the user U. The line-of-sight detection device 238 may be a camera that images a line of sight and that is attached to a VR goggle which will be described later. The second controller 270 derives a line of sight based on information input from the line-of-sight detection device 238. Various techniques for this are known, and thus detailed description thereof will be omitted.

The second speaker 240 outputs the audio acquired via the second communication device 210 and uttered by the passenger P. The second speaker 240 has, for example, a function of changing a direction in which the audio is heard. The second controller 270 outputs the audio from the second speaker such that the user U can hear the audio from the position of the occupant P when seen from the passenger's seat S2. The second speaker 240 may include a plurality of child second speakers 240-n (where n is two or more natural numbers). In this case, a sound image may be localized by causing the second controller 270 to adjust the sound volumes of the child second speakers 240-n, or a sound image may be localized using a function of a headphone when the headphone is accessory to the VR goggle.

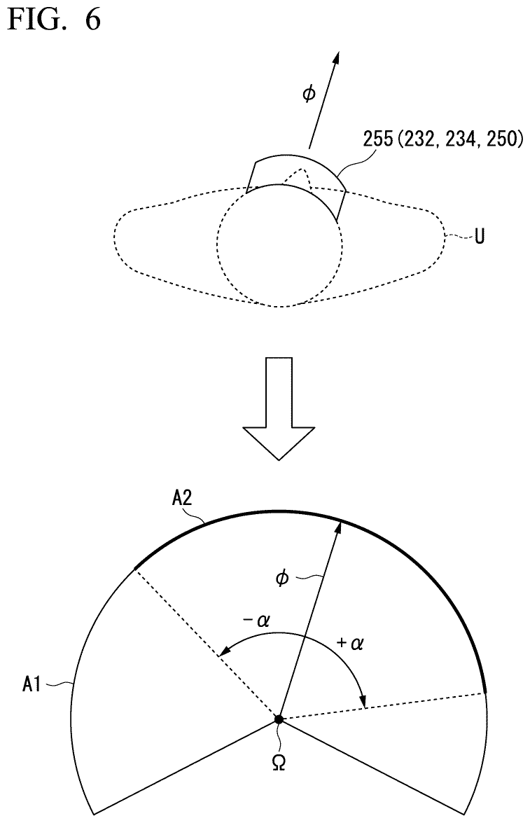

The mobile object image display device 250 displays an image corresponding to the direction of orientation when seen from the passenger's seat out of images captured by the camera unit 130 (which may be images subjected to the aforementioned combination process and which are referred to as mobile-object images in the following description). FIG. 6 is a diagram showing an image corresponding to the direction of orientation. In the example shown in the drawing, the direction-of-orientation detection device 232, a physical sensor as the head position detection device 234, and the mobile object image display device 250 are included in a VR goggle 255. For example, the second controller 270 detects the facing direction of the VR goggle 255 as a direction of orientation φ with the center of the head of the user U or the center of the VR goggle 255 as 6 and a previously calibrated direction as a reference direction. Various techniques for this function are known, and thus detailed description thereof will be omitted.

The mobile object image display device 250 displays an image A2 in an angle range of ±α from the direction of orientation φ in a mobile object image A1 (which has an angle of about 240 degrees in the drawing, and the viewing angle may be extended through the aforementioned combination process) to the user U.

Referring back to FIG. 5, the HMI 260 is a touch panel, an audio response unit (an agent device), or the aforementioned switch. The HMI 260 receives various instructions from the user U for the second device 200.

The second controller 270 includes, for example, a processor such as a CPU and a storage medium connected to the processor and storing a program (an instruction group) and controls the constituents of the second device 200 by causing the processor to execute the instruction group. All the functions shown in FIG. 5 of the second device 200 may be incorporated into the VR goggle.

### Functional Configurations of First Controller 170 and Second Controller 270

The functional configurations of the first controller 170 and the second controller 270 will be described below. In a first example and a second example described below, it is assumed that generation, transmission, and the like of information which is provided between the first controller 170 and the second controller 270 are mainly performed and the management server 300 manages matching of simulated riding between a passenger P and a user U.

### First Example

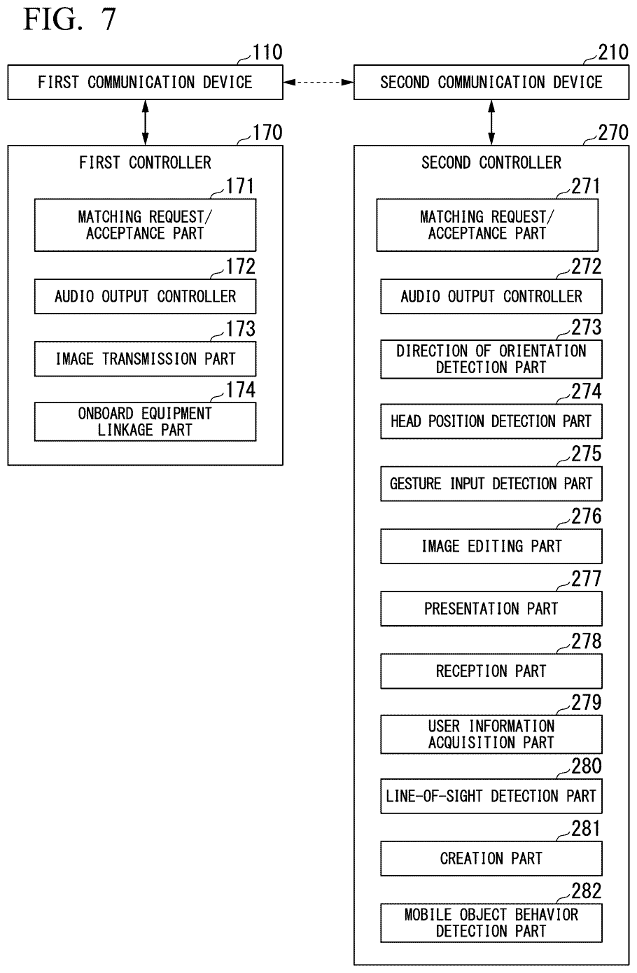

FIG. 7 is a diagram showing a first example of the functional configurations of the first controller 170 and the second controller 270. In the first example, the first controller 170 includes a matching request/acceptance part 171, an audio output controller 172, an image transmission part 173, and an onboard equipment linkage part 174. The second controller 270 includes a matching request/acceptance part 271, an audio output controller 272, a direction-of-orientation detection part 273, a head position detection part 274, a gesture input detection part 275, an image editing part 276, a presentation part 277, a reception part 278, a user information acquisition part 279, a line-of-sight detection part 280, a creation part 281, and a mobile object behavior detection part 282. These functional parts are realized, for example, by causing a processor such as a CPU to execute a program (an instruction group). Some or all of these functional parts may be realized by hardware (a circuit part including circuitry) such as an LSI circuit, an ASIC, an FPGA, or a GPU or may be cooperatively realized by software and hardware.

The matching request/acceptance part 171 receives an input of a matching request (a simulated riding request) from the passenger P using the HMI 160 and transmits the matching request to the management server 300, or receives an input of acceptance of the matching request received from the management server 300 using the HMI 160 and transmits the input of acceptance to the management server 300. The matching request/acceptance part 171 controls the first communication device 110 so as to communicate with the second device 200 of the matched user U. For example, the matching request/acceptance part 171 may receive settings of provision availability information indicating what information is permitted to be provided from the passenger P when the matching request obtained from the management server 300 is accepted.

The audio output controller 172 controls the first speaker 140 as described above.

The image transmission part 173 transmits a mobile object image A1 to the second device 200 using the first communication device 110 after starting communication with the second device 200. The mobile object image A1 may include, for example, an indoor image captured by the indoor camera 132 and/or an outdoor image captured by the outdoor camera 134.

The onboard equipment linkage part 174 controls control target equipment 190 based on an instruction signal input from the second device 200. The onboard equipment linkage part 174 acquires driving information of the mobile object M from the control target equipment 190 and transmits the acquired driving information to the second device 200 using the first communication device 110. The onboard equipment linkage part 174 may perform control when control of the control target equipment 190 by the user U is permitted by the passenger P.

The matching request/acceptance part 271 receives an input of a matching request (a simulated riding request) from the user U using the HMI 260 and transmits the matching request to the management server 300, or receives an input of acceptance of the matching request received from the management server 300 using the HMI 260 and transmits the input of acceptance to the management server 300. The matching request/acceptance part 271 controls the second communication device 210 to communicate with the first device 100 of the matched passenger P. For example, the matching request/acceptance part 271 may present what information is provided to the user U such that the user U ascertains the information based on a matching result (a request result) acquired from the management server 300 and receive an instruction for simulated riding or not from the user U.

The audio output controller 272 controls the second speaker 240 as described above.

The direction-of-orientation detection part 273 detects a direction of orientation φ based on the output from the direction-of-orientation detection device 232. The head position detection part 274 detects the height of the head of the user U based on the output from the head position detection device 234. The position of the head may be expressed by three-dimensional coordinates, or the height of the head may be simply detected as the position of the head.

The gesture input detection part 275 detects a gesture input from the user U based on the output from the motion sensor 236.

The image editing part 276 performs a process of cutting out an image A2 corresponding to the direction of orientation φ when seen from the passenger's seat S2 from the mobile object image A1 (FIG. 6). In the example shown in FIG. 6, the direction of orientation φ with respect to left or right movement of the head of the user U is shown, but a process of cutting out an image corresponding to the direction of orientation with respect to upward or downward movement of the head may be performed.

The presentation part 277 displays (presents) the image A2 cut out by the image editing part 276 on the mobile object image display device 250. At this time, the image editing part 276 may display an image corresponding to the direction of orientation φ when seen from the height indicated by the height information of the head of the user U on the mobile object image display device 250. For example, the image editing part 276 selectively displays an indoor image or an outdoor image according to a distance from the reference position of the head of the user U (for example, an amount of movement in the vertical direction or an amount of movement in the lateral direction). The presentation part 277 acquires an output signal of another second device 200 from the second communication device 210 and displays an icon on the mobile object image display device 250 based on position information included in the acquired output signal.

The reception part 278 receives an operation input from the user to the image A2 presented to the mobile object image display device 250 by the presentation part 277.

The user information acquisition part 279 acquires user information of users using the other second devices 200 out of the plurality of second devices 200. An example of the user information is information for communicating with the users of the other second devices 200.

The line-of-sight detection part 280 detects a line-of-sight direction based on an output of the line-of-sight detection device 238. The presentation part 277 identifies a position on the image (video) displayed on the mobile object image display device 250 and displays an icon at the identified position. For example, when an operation input of the user is performed on the HMI 260, the presentation part 277 identifies a position on the image (video) displayed on the mobile object image display device 250 instructed by the operation input and displays an icon at the identified position. The creation part 281 creates an output signal including the identified position information identified by the presentation part 277 and transmits the output signal from the second communication device 210 to the other second devices 200. For example, while seeing the image (video), the user performs an operation input by putting a focus at an arbitrary position on the image (video) using the HMI 260 held with a hand and pressing an input button. Specifically, the user performs the operation input by putting a symbol displayed on the image (video) on an arbitrary position using the HMI 260 held with a hand and pressing an input button.

Here, the presentation part 277 may identify a display area on the mobile object image display device 250 based on the position focused by the HMI 260. An icon may be displayed in the identified display area. For example, the presentation part 277 may display an icon at the center of the display area.

The creation part 281 may create notification information including the created output signal and transmit the notification information from the second communication device 210 to the first device 100. Accordingly, since the passenger P can be notified of a reaction result of the user, the passenger P can understand emotion of the user. Here, whether the passenger P is to be notified of the reaction result of the user may be instructed through an operation input to the HMI 260. Accordingly, it is possible to curb notification which may hinder driving of the passenger P.

For example, the presentation part 277 identifies a position on the mobile object image display device 250 based on the line-of-sight direction detected by the line-of-sight detection part 280 and displays an icon on a target (object) displayed at the identified position. The creation part 281 creates an output signal including the position information identified by the presentation part 277 and transmits the output signal from the second communication device 210 to the other second devices 200.

Here, the presentation part 277 may identify a display area on the mobile object image display device 250 based on the line-of-sight direction detected by the line-of-sight detection part 280 and display an icon on a target (object) displayed in the identified display area. For example, the presentation part 277 may display an icon at the center of the display area. An example of the display area is a bounding box. In this case, the creation part 281 creates an output signal including information indicating the display area identified by the presentation part 277 and transmits the output signal to the other second devices 200.

When the mobile object M (vehicle) is traveling along a road, a shape or a color of a target does not change much. When there is no right turn or left turn or the like, the recognized target looks like approaching the vehicle and then being cut out from the screen. The presentation part 277 may change the identified position or display area based on traveling of the mobile object M. The presentation part 277 may continue to display the icon at the same position according to the positional relationship between the identified position and the identified display area.

Driving information of the mobile object M transmitted from the first device 100 is received by the second communication device 210. The mobile object behavior detection part 282 acquires the driving information of the mobile object M from the second communication device 210 and detects that the mobile object M has turned to right or left based on the acquired driving information of the mobile object M.

When the mobile object behavior detection part 282 detects that the mobile object M has turned to right or left after the icon has been presented, the presentation part 277 changes details of an output result to be presented. For example, the presentation part 277 displays the icon such that the icon is different from that when the mobile object M does not turn to left or right or the like. For example, the presentation part 277 displays the icon in a dotted line. For example, the presentation part 277 determines whether the icon continues to be displayed at the identified position based on the video displayed on the mobile object image display device 250 and displays the icon in a dotted line when it is determined that the icon does not continue to be displayed.

### Second Example

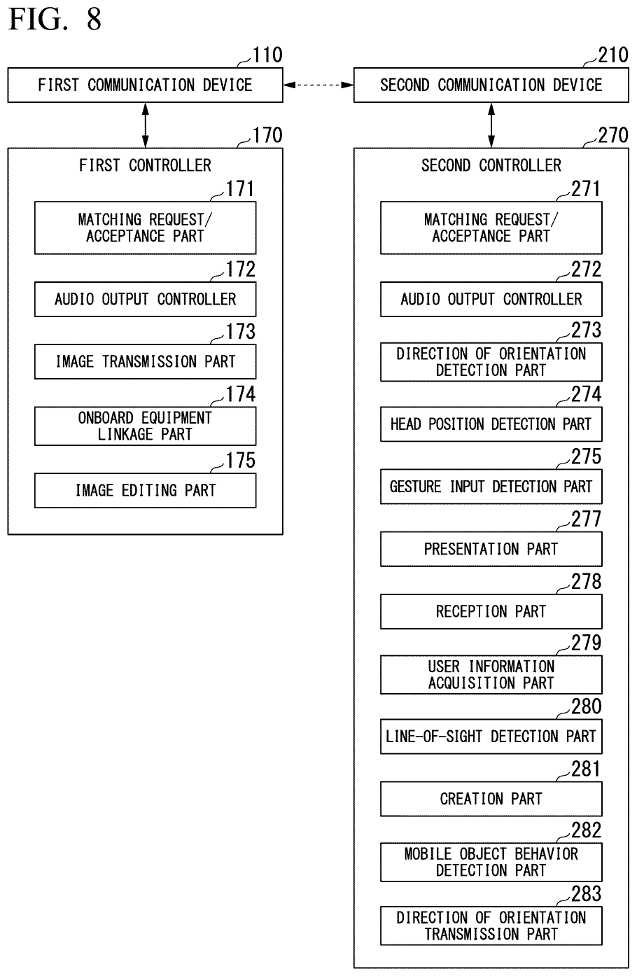

FIG. 8 is a diagram showing a second example of the functional configurations of the first controller 170 and the second controller 270. The second example is different from the first example shown in FIG. 7 in that the first controller 170 includes an image editing part 175 and the second controller 270 does not include the image editing part 276 but includes a direction-of-orientation transmission part 283. The other constituents basically have the same functions as in the first example, and thus repeated description thereof will be omitted. The direction-of-orientation transmission part 283 transmits the direction of orientation φ detected by the direction-of-orientation detection part 273 to the first device 100 using the second communication device 210.

The image editing part 175 performs a process of cutting out the image A2 corresponding to the direction of orientation φ (transmitted from the second device 200) when seen from the passenger's seat (FIG. 6). At this time, the image editing part 175 may acquire height information of the head of the user U from the second device 200 and perform the process of cutting out the image A2 corresponding to the direction of orientation φ when seen from the height indicated by the height information.

The image transmission part 173 in the second example transmits the image A2 cut out by the image editing part 175 to the second device 200 using the first communication device 110. Then, the presentation part 277 displays the image A2 transmitted from the first device 100 on the mobile object image display device 250.

### Process Associated With Simulated Riding

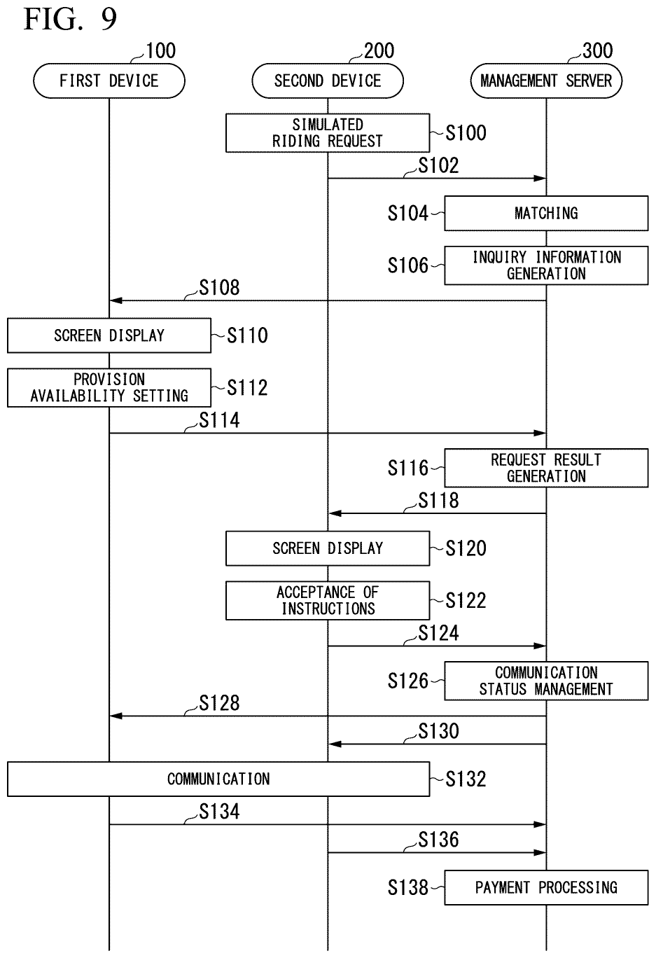

A flow of a series of processes that is performed by the information processing system 1 when a user U rides on the mobile object M in a simulated manner (when the passenger P allows the user U to ride in a simulated manner) according to the embodiment will be described below in detail. FIG. 9 is a sequence diagram showing an example of the process flow that is performed by the information processing system 1. In the example shown in FIG. 9, processes that are performed by the first device 100 mounted in the mobile object M in which the passenger P rides, the second device 200 that is used by the user U, and the management server 300 are shown. It is assumed that the user U and the passenger P are registered in the management server 300 in advance and are registered in the user data 360 in order to receive provision of a service in the information processing system 1.

In the example shown in FIG. 9, the second device 200 generates a request for simulated riding (a simulated riding request) (Step S100) and transmits the generated simulated riding request to the management server 300 (Step S102). The simulated riding request may include information for designating a passenger P in advance or may include information for designating a current position or a destination of the traveling mobile object M, a surrounding situation thereof, or the like. More specific examples of the simulated riding request include requests such as “I want to simulate riding in a mobile object driven by Mr. A” and “I want to simulate riding in a mobile object traveling on a seashore road. ”These are examples of the matching request.

The matching processing part 320 of the management server 300 receives the simulated riding request from the second device 200 and performs a matching process based on the user data 360 (Step S104). Then, when there are one or more mobile objects M matched, the provision part 330 generates inquiry information for inquiring of all the mobile objects M about whether to perform simulated riding (Step S106) and transmits the generated inquiry information to the first devices 100 of the matched mobile objects M (step S108).

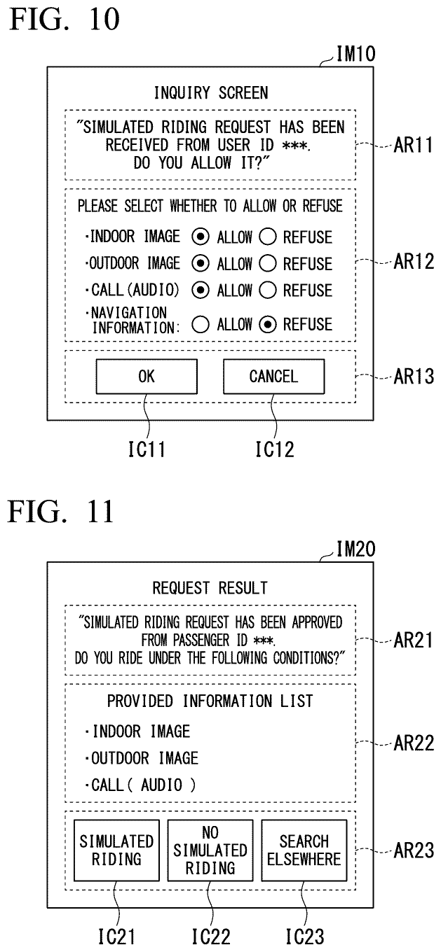

The first device 100 displays the inquiry information transmitted from the management server 300 on a screen (Step S110). FIG. 10 is a diagram showing an example of an image IM10 indicating the inquiry information. A display mode such as display details or a layout included in the image IM10 is not limited thereto. The same is true of the following description of other images. The image IM10 includes, for example, a user information display area AR11, a provision availability selection area AR12, and a switch display area AR13 as an inquiry screen. Information on the user U who has transmitted a simulated riding request is displayed in the user information display area AR11. The information on the user U may be a user ID or other information with which the passenger P can identify the user U.

An image for selecting details of information which the passenger P provides to the user U for each piece of information is displayed in the provision availability selection area AR12. In the example shown in FIG. 10, a screen for selecting whether to allow provision of information to the passenger P is displayed for an indoor image, an outdoor image, a call (audio), and navigation information (information provided from a navigation device). The call (audio) is an example of “indoor audio information. ” For example, when the passenger P allows provision of a call or an image to the user U but does not want a destination to be specifically notified, the passenger P allows provision of a call or provision of an indoor image and an outdoor image and prohibits provision of navigation information. Accordingly, for example, when a user U rides actually in the mobile object M, the user U can simply see a destination from the navigation information. However, by refusing provision of the navigation information to the user U at the time of simulated riding, it is possible to travel to a destination in secret from the user U and to allow the user U to have surprising experience which is specific to the simulated riding. For example, by refusing provision of a call (audio) for a user U who is not intimate much, the user can drive without conversation. The information for selecting provision availability is not limited to the example shown in FIG. 10 and may include, for example, information for selecting whether a navigation operation by the user U or an operation on other control target equipment 190 is available or information for selecting whether provision of an image including the passenger P is possible. The provision information availability selected in the provision availability selection area AR12 may be changed during the simulated riding. The switch display area AR13 includes, for example, an icon IC11 and an icon IC12. The icon IC11 is a switch for receiving allowance of simulated riding of the user U from the passenger P. On the other hand, the icon IC12 is a switch for receiving refusal of simulated riding of the user U from the passenger P.

Referring back to FIG. 9, the first device 100 receives provision availability setting information of the user U via the image IM10 shown in FIG. 10 (Step S112) and transmits the received provision availability setting information to the management server 300 (Step S114). In the processes of Steps S110 to S112, a screen may be displayed when the mobile object M stops in order to secure safety during driving, and a simulated riding request may be notified of using an audio or provision availability setting information may be received instead of (or in addition to) the screen display. The provision part 330 of the management server 300 generates a request result (a response result) based on the provision availability setting information acquired from the first device 100 (Step S116) and transmits information indicating the generated request result to the second device 200 (step S118).

The second device 200 receives the request result from the management server 300 and displays information indicating the received request result on the screen (Step S120). FIG. 11 is a diagram showing an example of an image IM20 indicating a request result. The image IM20 includes, for example, a passenger information display area AR21, a provision information list display area AR22, and a switch display area AR23 as a request result screen. The image IM20 may be generated for each passenger P (each mobile object M) whose simulated riding has been permitted, or an image indicating a list of request results may be displayed.

In the passenger information display area AR21, information on a passenger P having accepted a simulated riding request is displayed. The information on a passenger P may be a passenger ID or other information used for the user U to identify the passenger P. In the provision information list display area AR22, information accepted by the passenger P is displayed in a list. In the provision information list display area AR22, a fee (a service fee) based on the accepted information may be displayed. The switch display area AR23 includes, for example, icons IC21 to IC23. The icon IC21 is a switch for receiving simulated riding in the mobile object M of the passenger P displayed in the passenger information display area AR21 using provided information displayed in the provision information list display area AR22. On the other hand, the icon IC22 is a switch for receiving an instruction not to perform simulated riding. The icon IC23 is a switch for receiving an instruction to search for another passenger (mobile object). When another passenger is searched for, the passenger may be selected from other passengers included in the request result, or other request conditions may be input to cause the management server 300 to perform a matching process again.

Referring back to FIG. 9, the second device 200 receives a selection instruction from the user U using the image IM20 shown in FIG. 11 (Step S122) and transmits information of the received instruction to the management server 300 (Step S124). In the following description, it is assumed that the user U has given an instruction for the user U to perform simulated riding in the mobile object M of the passenger P. The management server 300 manages a communication situation between the first device 100 and the second device 200 based on an instruction from the second device 200 (Step S126) and transmits information indicating that simulated riding is performed to the first device 100 and the second device 200 (Steps S128 and S130). In the processes of Steps S126 to S130, when it is selected that the user U does not perform simulated riding, the provision part 330 of the management server 300 transmits information indicating that fact to the first device 100 to notify the user U.

Then, the first device 100 and the second device 200 perform simulated riding by communicating with each other (Step S132) and transmits information indicating that communication has ended to the management server 300 when the simulated riding ends (Steps S134 and S136). In the process of Step S132, the second device 200 may perform notification from the user U to the passenger P before the information from the first device 100 is provided to the second device 200. Accordingly, the user U can start provision of information such as calling or video transmission by allowing communication at a desired timing. Then, the fee management part 340 of the management server 300 performs a fee payment process associated with use of a service for each of the first device 100 and the second device 200. Specifically, the fee management part 340 sets fees for information provision to be different based on at least one of a passenger P providing information, a user U, a type of a mobile object M, the type of information which can be provided to a user U, and the amount of information.

For example, when the passenger P or the user U is a celebrity, the fee thereof is set to be higher than a regular fee. Alternatively, when the mobile object M is a new vehicle or a rare vehicle (a rare car), the fee thereof is set to be higher than a regular fee. The fee management part 340 performs a payment process corresponding to the set fee. In this way, the process flow of the present sequence ends. The process of Step S112 (a provision availability setting process) in FIG. 9 may be set in advance for each registered user U by the passenger P.

### Icon Displaying Process

In the present embodiment, a series of processes which is performed by the information processing system 1 when a user U1 and a user U2 perform simulated riding in a mobile object M1 and the user U1 displays an icon on the mobile object image display device 250 of a second device 200-2 by performing an operation input when an image A is displayed on the mobile object image display device 250 of a second device 200-1 will be specifically described below.

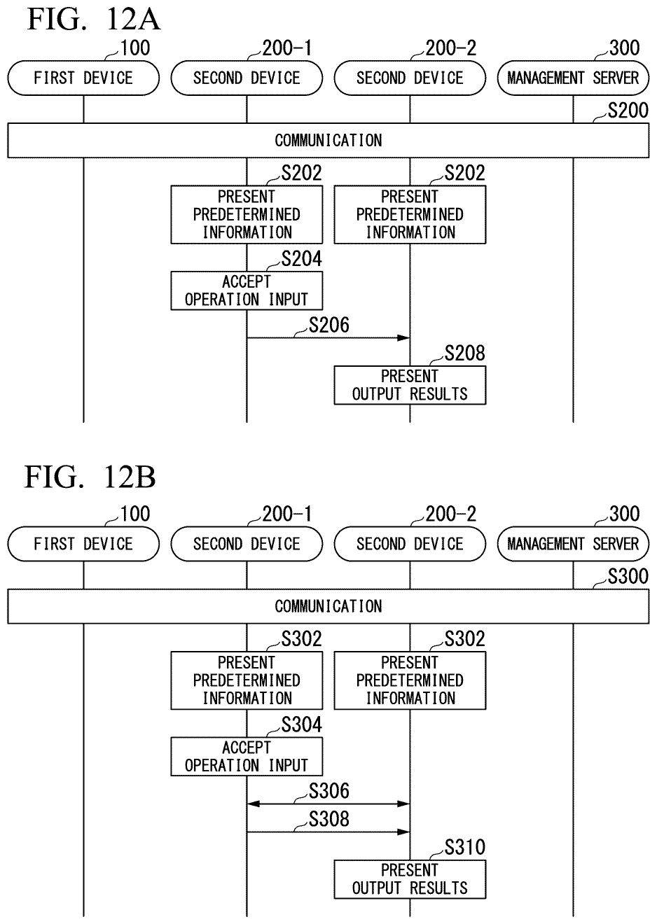

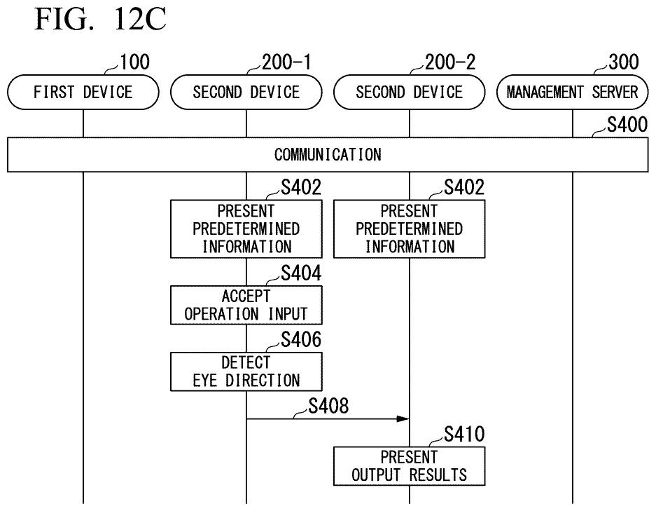

FIG. 12A is a sequence diagram showing a first example of a process flow that is performed by the information processing system 1. The first device 100, the second device 200-1, the second device 200-2, and the management server 300 perform simulated riding by communicating with each other (Step S200). In FIG. 12A, the first device 100 acquires user information used to communicate with the second devices 200 in advance.

The second device 200-1 and the second device 200-2 present predetermined information such as an image A2 to the mobile object image display device 250 (Step S202). The presentation part 277 of each of the second device 200-1 and the second device 200-2 displays (presents) the image A2 cut out by the image editing part 276 on the mobile object image display device 250.

The second device 200-1 receives an operation input from the user U1 (Step S204), creates an output signal based on the received operation input, and transmits the output signal to the second device 200-2 (Step S206). The operation input may be, for example, a tapping operation that is performed on at least a partial area of a video displayed on the mobile object image display device 250 by a user U using the HMI 260. For example, the user U taps a predetermined position such as a place which the user wants to remotely see and which is included in the video displayed on the mobile object image display device 250. The HMI 260 acquires an input of the tapping operation performed by the user U. The creation part 281 creates an output signal including information of the tapped position based on the tapping operation acquired by the HMI 260 and transmits the output signal to the second device 200-2.

The presentation part 277 of the second device 200-2 displays an icon on the mobile object image display device 250 based on the output signal from the second device 200-1 (Step S208). For example, the presentation part 277 of the second device 200-2 acquires the output signal from the second device 200-1 from the second controller 270 and acquires position information included in the acquired output signal. The presentation part 277 of the second device 200-2 presents an icon to the image A displayed on the mobile object image display device 250 based on the acquired position information.

FIG. 12B is a sequence diagram showing a second example of the process flow that is performed by the information processing system 1. The first device 100, the second device 200-1, the second device 200-2, and the management server 300 perform simulated riding by communicating with each other (Step S300).

The second device 200-1 and the second device 200-2 present predetermined information such as an image A2 to the mobile object image display device 250 (Step S302). The presentation part 277 of each of the second device 200-1 and the second device 200-2 displays (presents) the image A2 cut out by the image editing part 276 on the mobile object image display device 250.

The second device 200-1 receives an operation input from the user U1 (Step S304), acquires user information of the user U2 from the second device 200-2 (Step S306), creates an output signal based on the received operation input and the user information of the user U2, and transmits the output signal to the second device 200-2 (Step S308). The operation input may be, for example, a tapping operation that is performed on at least a partial area of a video displayed on the mobile object image display device 250 by a user U using the HMI 260. For example, the user U taps a predetermined position such as a place which the user wants to remotely see and which is included in the video displayed on the mobile object image display device 250. The HMI 260 acquires an input of the tapping operation performed by the user U. The user information acquisition part 279 acquires user information of a user U2 who uses the second device 200-2. An example of the user information of the user U2 is information used to communicate with the second device 200-2. The creation part 281 creates an output signal including information of the tapped position based on the tapping operation acquired by the HMI 260 and the user information of the user U2 and transmits the output signal to the second device 200-2.

Step S310 is the same as Step S208 in FIG. 12A, and thus description thereof will be omitted.

FIG. 12C is a sequence diagram showing a third example of the process flow that is performed by the information processing system 1. The first device 100, the second device 200-1, the second device 200-2, and the management server 300 perform simulated riding by communicating with each other (Step S400).

The second device 200-1 and the second device 200-2 present predetermined information such as an image A2 to the mobile object image display device 250 (Step S402). The presentation part 277 of each of the second device 200-1 and the second device 200-2 displays (presents) the image A2 cut out by the image editing part 276 on the mobile object image display device 250.

The second device 200-1 receives an operation input from the user U1 (Step S404), detects the line-of-sight direction of the user U1 (Step S406), creates an output signal based on the received operation input and the line-of-sight direction of the user U1, and transmits the output signal to the second device 200-2 (Step S408). The operation input may be, for example, a button pressing operation or a gesture input that is performed on at least a partial area of a video displayed on the mobile object image display device 250 by a user U using the HMI 260. For example, the user U performs the button pressing operation or the gesture input while seeing a predetermined position such as a place which the user wants to remotely see and which is included in the video displayed on the mobile object image display device 250. The line-of-sight detection part 280 detects the line-of-sight direction of the user U1 and acquires predetermined position information. The HMI 260 acquires the button pressing operation or the gesture input performed by the user U. The creation part 281 creates an output signal including the position information based on the predetermined position information acquired by the line-of-sight detection part 280 and the button pressing operation or the gesture input acquired by the HMI 260 and transmits the output signal to the second device 200-2.

Step S410 is the same as Step S208 in FIG. 12A, and thus description thereof will be omitted.

In FIGS. 12A to 12C, for example, it is assumed that the information processing system 1 includes two second devices 200, but the present embodiment can be applied to a case in which the information processing system 1 includes three or more second devices 200.

### Information Provided in Simulated Riding

Information which is provided to a user U in simulated riding will be described below. The following example is information which is provided in the process of Step S208 in FIG. 12A, the process of Step S310 in FIG. 12B, and the process of Step S410 in FIG. 12C. For example, an output mode of information to be provided to a second device 200 varies according to an operation of the user U or an information type or the amount of information which can be provided to the user U. In the following example, it is assumed that provision of an indoor image, an outdoor image, and a call (an audio) is allowed by a passenger P.

### Example of Provided Information: Indoor Image

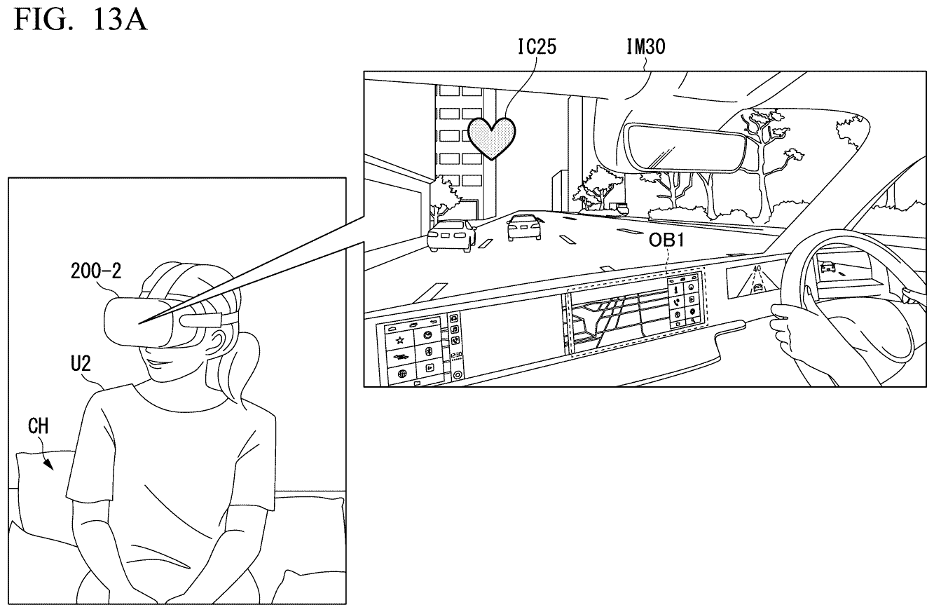

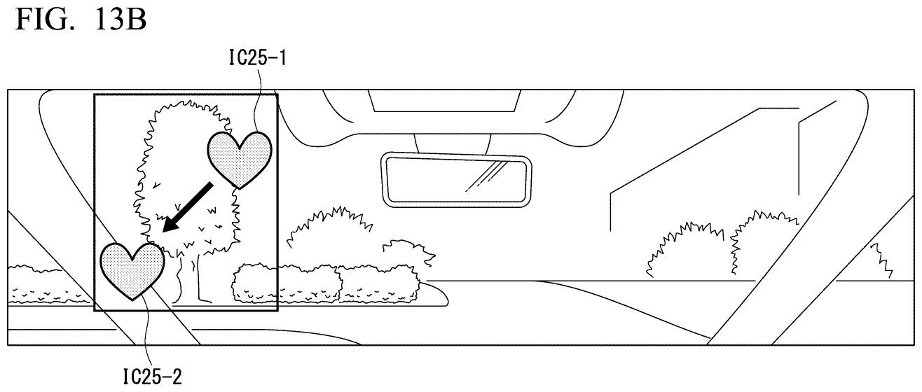

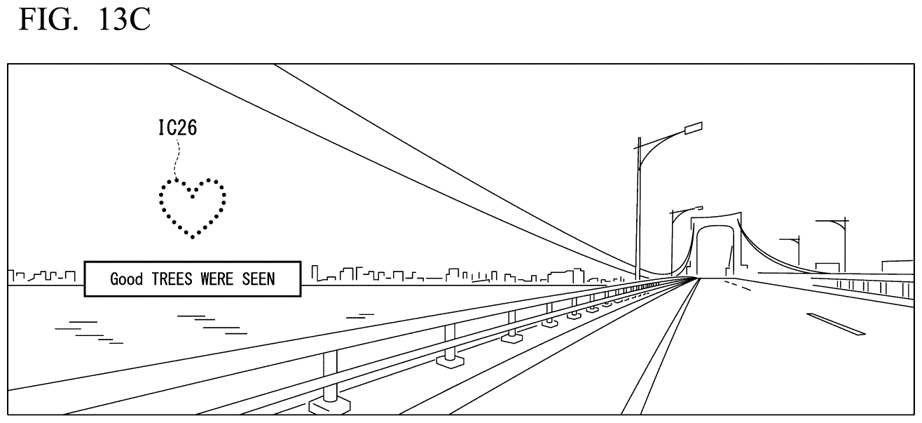

FIG. 13A is a diagram showing an example of provided information. In the example shown in FIG. 13A, a user U who sits on a chair CH in a place (for example, a home room) other than a mobile object M and an image IM30 which is provided by a second device 200 (a built-in VR goggle in the example shown in FIG. 13A) used by the user U are shown. Here, for example, it is assumed that the second device 200 is a built-in VR goggle, but the second device 200 may be head-mounted display or the like. The image IM30 includes a heart-shaped icon IC25. A state of the user U (a state in which the user U sits on the chair CH) in the example shown in FIG. 13A is an initial state immediately after simulated riding has been performed, and the first device 100 and the second device 200 recognize a position of the user U at that time (a reference posture) as a reference position. The reference position is a position at which the user U is assumed to sit on a passenger's seat S2. Regarding the reference position, the height of the indoor camera 132 may be corrected to be suitable for a sitting height of the user U by causing the first controller 170 to drive a seat drive device based on physique information such as a height or a sitting height of the user U registered in user information of the user data 360 (so-called 0-point correction). The reference position may be corrected in accordance with a correction instruction from the user U seeing the image IM30. The reference position may include direction information when the user U sits on the chair CH and gazes at front.

For example, when the user U (the second device 200) gazes at an arbitrary direction from the reference position in a state in which the user U sits on the chair CH, an image captured by the indoor camera 132 of the first device 100 is provided as an indoor image IM30 according to the direction. Accordingly, the user U can acquire an indoor image in an arbitrary direction when seen from the passenger's seat S2. An audio of the passenger P acquired by the first microphone 120 or audio information of an indoor audio and an outdoor audio of the mobile object M is provided to the user U. The user U can enjoy a conversation as if the user U were actually riding in the mobile object M by making a conversation with the passenger P using the image IM30 or the audio information.

In the information processing system 1, the user U can see an arbitrary direction when seen from the passenger's seat S2, and the direction which the user U can see may be limited, for example, according to determination for matching or setting of provision availability of the passenger P. For example, the passenger P side may want to provide a view in the traveling direction of the mobile object M or a view on the side opposite to the driver's seat S1 but may not want to display the passenger's image. This is based on the assumption that the passenger P and the user U do not have a relationship of family or friends and cope with requirements for enjoying driving feeling in the mobile object M or seeing a desired street view. In this case, the matching processing part 320 or the provision part 330 of the management server 300 sets the limitation based on the matching result. The first controller 170 or the second controller 270 masks an angle range which is not to be seen or performs correction such that the direction of orientation φ is not directed to a limited direction. Information on such limitation is associated with privacy of the passenger P and thus may be set by the first device 100 side. Information of which provision is to be refused may be provided after the passenger P has accepted through payment of an additional fee from the user U.

The mobile object image display device 250 may replace a part in which a predetermined article inside of the mobile object M is imaged in an image captured by the camera unit 130 with an image drawn by computer processing (a CG image) and display the resultant image. An area OB1 shown in FIG. 13A is a display device performing navigation display or the like and is an example of the “predetermined article.” When an image obtained by imaging a display screen of the display device is displayed without any change, the image may be blurred or visibility thereof may decrease due to reflection of light. Accordingly, the mobile object image display device 250 may acquire data for constructing the display screen of the display device or image data drawn through computer processing in the mobile object M from the first device 100 and embed and display an image re-drawn from the data through computer processing or the acquired image data in an image (or an edited image) captured by the camera unit 130. In this case, a position of an article inside of the mobile object M which is the predetermined article is shared in advance by the first device 100 and the second device 200, and the presentation part 277 determines whether the predetermined article is included in the image displayed on the mobile object image display device 250, for example, based on the direction of orientation φ and performs the aforementioned replacement of an image when it is determined that the predetermined article is included in the image. The “predetermined article” may be the head or face of the passenger P. In this case, a CG image such as an avatar may be changed according to an instruction of the passenger P. At least a part of the image data (the CG image) or the like may be provided from the provided information DB of the management server 300.

FIG. 13B is a diagram showing an example of provided information. In the second communication device 210, the presentation part 277 changes a presentation position of an icon based on the speed of the mobile object M. For example, the presentation part 277 recognizes a position to which an icon has been output and displays the icon to flow rearward according to the speed of the mobile object M. For example, the presentation part 277 acquires information indicating the moving speed of the mobile object M from the first device 100 and changes the position form an icon IC25-1 to an icon IC25-2 based on the acquired speed of the mobile object M. By changing the position from the icon IC25-1 to the icon IC25-2 to provide a dynamic visual effect, it is possible to provide a more real and attractive experience to the user U. By adjusting movement of the icon IC25 according to a vehicle speed, it is possible to maintain visual consistency for the user U.

FIG. 13C is a diagram showing an example of provided information. In the second device 200, when the mobile object behavior detection part 282 detects that left turn, right turn, or the like of the mobile object M has occurred after the user U has performed a tapping operation, the presentation part 277 displays an icon unlike a case in which left turn, right turn, or the like of the mobile object M has not occurred. For example, the presentation part 277 displays the icon in a dotted line. For example, the presentation part 277 determines whether at least a partial area of a video on which a tapping operation has been performed by the user U continues to be displayed based on the video displayed on the mobile object image display device 250 and displays the icon in a dotted line when it is determined that the at least a partial area does not continue to be displayed.

Here, the presentation part 277 may determine whether an identified display area (a bounding box) continues to be displayed on the mobile object image display device 250 based on the line-of-sight direction detected by the line-of-sight detection part 280 and display the icon in a dotted line when it is determined that the identified display area does not continue to be displayed.

The presentation part 277 may display the icon in a dotted line and display information indicating an object displayed in the icon together. In FIG. 13C, an icon IC26 is displayed in a dotted line, and “Good trees were seen” is displayed as information indicating an object displayed therein (such as trees, buildings, utility poles, and sea).

In the aforementioned embodiment, the second device 200 may be configured to receive an operation input from the user U and then to receive an operation for canceling the operation input. For example, a predetermined cancel operation input may be performed by the user U using the HMI 260 in a state in which an icon is displayed in at least a partial area of the video displayed on the mobile object image display device 250. For example, the user U performs a cancel operation with a focus on the icon displayed on the mobile object image display device 250 using the HMI 260. The user U may perform the cancel operation while seeing the icon displayed on the mobile object image display device 250. The line-of-sight detection part 280 detects the line-of-sight direction of the user U1 and acquires position information of the icon. The HMI 260 receives the cancel operation performed by the user U. The creation part 281 creates a cancel signal including the position information based on the position information of the icon acquired by the line-of-sight detection part 280 and the cancel operation input received by the HMI 260 and transmits the cancel signal to the other second device.

The presentation part 277 of the other device deletes the icon based on the cancel signal from the corresponding second device 200. For example, the presentation part 277 of the other second device acquires the cancel signal from the second device 200 from the second controller 270 and acquires the position information included in the acquired output signal. The presentation part 277 of the other second device deletes the icon displayed in the image A presented to the mobile object image display device 250 based on the acquired position information.

In the aforementioned embodiment, the plurality of second devices 200 may include a display part that can display a video. In this case, screens (such as televisions) located at home in addition to a VR goggle may be used as the second devices 200. The second devices such as screens may include a reception part for receiving an operation input or may not include such a reception part. When a reception part is not included, the second devices 200 may present a result of an operation input received by a reception part of another second device 200.

### Modified Examples

In the information processing system 1, when an operation input from a user U to an image A2 is received, each second device 200 detects an arbitrary position in the image A2 based on the operation input and acquires POI information of the detected position. The second device 200 displays the acquired POI information and an icon on the mobile object image display device 250. The second device 200 creates an output signal including the arbitrary position information in the image A2 detected based on the operation input and the POI information and transmits the output signal to the other second devices 200. The second devices 200 display the icon and the POI information on the mobile object image display device 250 based on the position information and the POI information included in the output signal from the other second device 200.

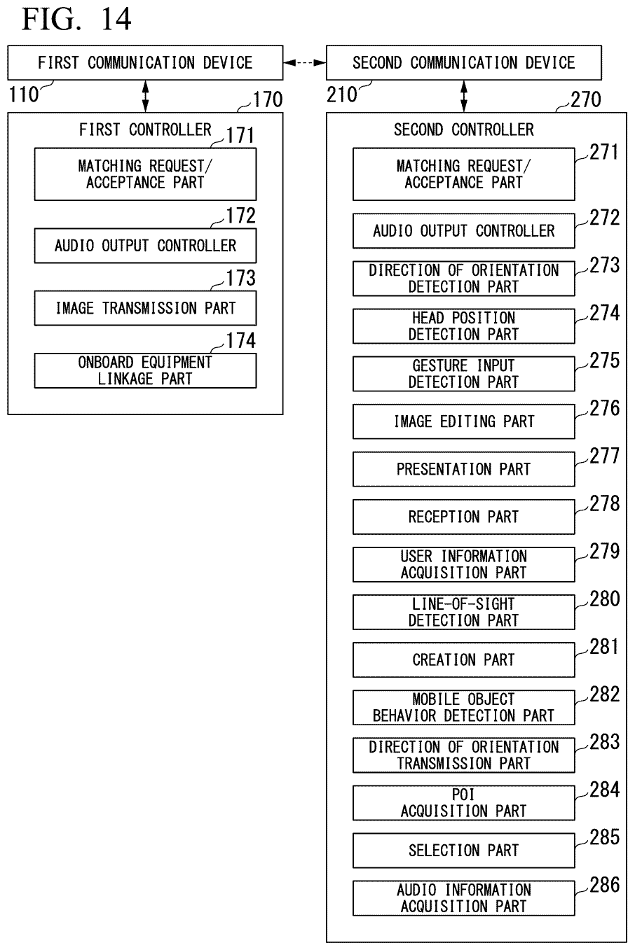

FIG. 14 is a diagram showing a third example of the functional configurations of the first controller 170 and the second controller 270. The third example is different from the first example shown in FIG. 7 in that the second controller 270 includes a POI acquisition part 284, a selection part 285, and an audio information acquisition part 286. The other constituents have the same functions as in the first example, and thus repeated description thereof will be omitted.

When a user's operation input to an image A2 presented to the mobile object image display device 250 by the presentation part 277 is received, the POI acquisition part 284 identifies a position in the image A2 based on the operation input and acquires POI information based on information indicating the identified position. The POI acquisition part 284 may acquire information indicating a gaze position of a user U from the line-of-sight detection part 280 and acquire POI information based on the acquired information indicating the gaze position of the user U. For example, the POI acquisition part 284 may acquire the POI information from the management server 300. The presentation part 277 acquires the POI information from the POI acquisition part 284 and displays the POI information in addition to an icon when the image A2 is displayed (presented) on the mobile object image display device 250.

When a plurality of pieces of POI information are acquired by the POI acquisition part 284, the selection part 285 selects POI information to be displayed along with an icon. For example, the selection part 285 may select POI information which is nearest (closest to the mobile object M) out of the plurality of pieces of POI information. In this case, the presentation part 277 acquires the POI information from the selection part 285 and displays the PIO information in addition to the icon when the image A2 is displayed (presented) on the mobile object image display device 250. Here, the selection part 285 may select arbitrary POI information out of the plurality of pieces of POI information.

The audio information acquisition part 286 acquires audio information based on the audio collected by the second microphone 220.

The presentation part 277 identifies a position on the image (video) displayed on the mobile object image display device 250 and instructed by the operation input and outputs an audio based on the audio information acquired by the audio information acquisition part 286 when an icon is displayed at the identified position. The creation part 281 creates an output signal including the position information identified by the presentation part 277 and the audio information acquired by the audio information acquisition part 286 and transmits the output signal from the second communication device 210 to the other second device 200. Here, the presentation part 277 may display POI information in addition to the icon when the image A2 is displayed (presented) on the mobile object image display device 250 and output an audio based on the audio information acquired by the audio information acquisition part 286 in association with the POI information. The creation part 281 may create an output signal including the position information identified by the presentation part 277, the POI information acquired by the POI information acquisition part 284, and the audio information acquired by the audio information acquisition part 286 and transmit the output signal to the other second devices 200 via the second communication device 210.

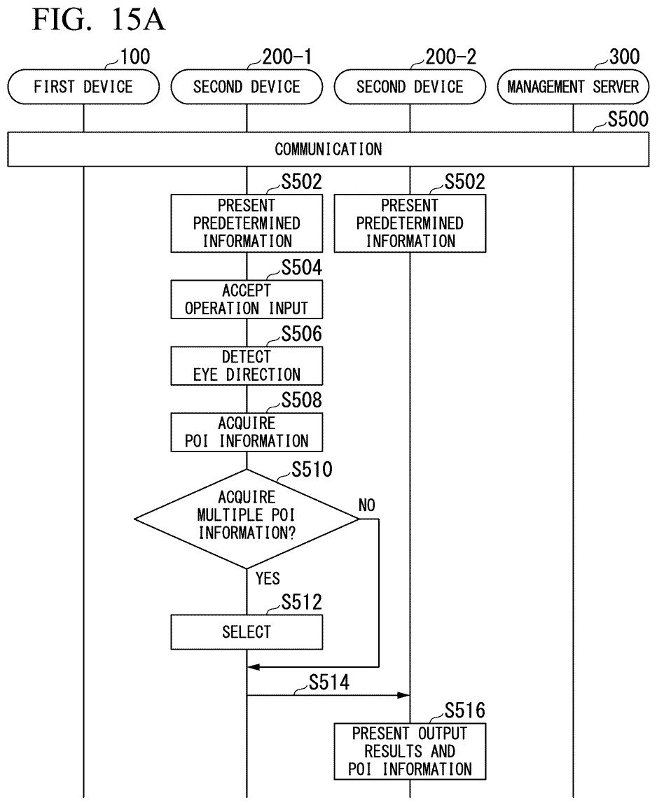

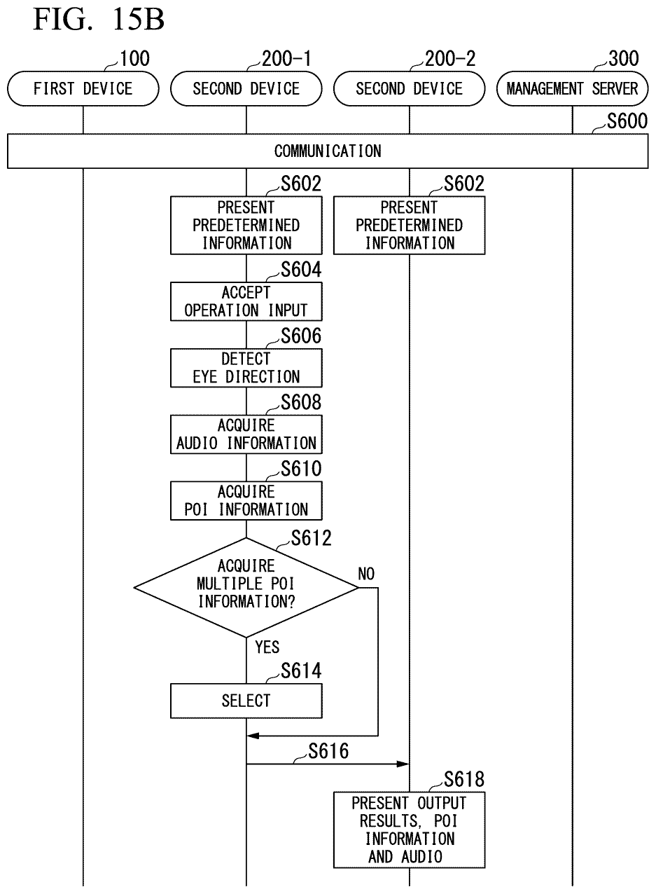

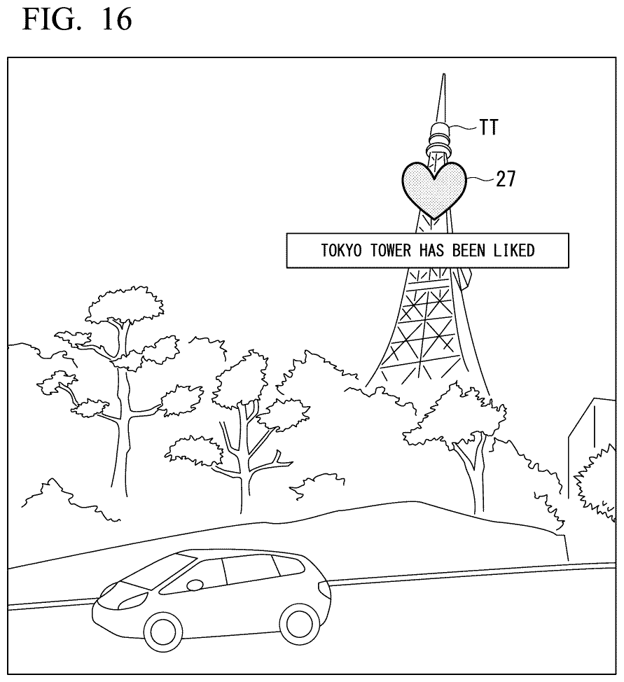

FIG. 15A is a sequence diagram showing a fourth example of the process flow that is performed by the information processing system 1. The first device 100, the second device 200-1, the second device 200-2, and the management server 300 perform simulated riding by communicating with each other (Step S500).

The second device 200-1 and the second device 200-2 present predetermined information such as an image A2 to the mobile object image display device 250 (Step S502). The presentation part 277 of each of the second device 200-1 and the second device 200-2 displays (presents) the image A2 cut out by the image editing part 276 on the mobile object image display device 250.

The second device 200-1 receives an operation input from the user U1 (Step S504), detects a line-of-sight direction of the user U1 (Step S506), and acquires POI information based on a gaze position of the user U1 (Step S508). The operation input may be, for example, a button pressing operation or a gesture input that is performed on at least a partial area of a video displayed on the mobile object image display device 250 by a user U using the HMI 260. For example, the user U performs the button pressing operation or the gesture input while gazing at a predetermined position such as a place which the user wants to remotely see and which is included in the video displayed on the mobile object image display device 250. The line-of-sight detection part 280 detects the line-of-sight direction of the user U1 and acquires information of the predetermined position. The POI acquisition part 284 acquires information indicating the gaze position of the user U from the line-of-sight detection part 280 and acquires POI information based on the information indicating the acquired gaze position of the user U.

The second device 200-1 determines whether the number of pieces of the acquired POI information is two or more (Step S510). When a plurality of pieces of POI information are acquired, the second device 200-1 selects POI information to be displayed along with an icon out of the plurality of pieces of POI information (Step S512), creates an output signal including the information indicating the gaze position and the POI information, and transmits the output signal to the second device 200-2 (Step S514). When a plurality of pieces of POI information are acquired by the POI acquisition part 284, the selection part 285 selects the POI information to be displayed along with an icon. For example, the selection part 285 selects POI information which is nearest (closest to the mobile object M) out of the plurality of pieces of POI information. The creation part 281 creates an output signal including the POI information and the position information based on the predetermined position information acquired by the line-of-sight detection part 280 and the button pressing operation or the gesture input acquired by the HMI 260 and transmits the output signal to the second device 200-2.

The presentation part 277 of the second device 200-2 displays the icon and the POI information on the mobile object image display device 250 based on the output signal from the second device 200-1 (Step S516). For example, the presentation part 277 of the second device 200-2 acquires the output signal from the second device 200-1 from the second communication device 210 and acquires the position information and the POI information included in the acquired output result. The presentation part 277 of the second device 200-2 presents the icon and the POI information to the image A presented on the mobile object image display device 250 based on the acquired position information.

FIG. 15B is a sequence diagram showing a fifth example of the process flow that is performed by the information processing system 1. Steps S600 to S606 and Steps S610 to S614 are the same as Steps S500 to S512 in FIG. 15A, and thus description thereof will be omitted.

In Step S608, the audio information acquisition part 286 of the second device 200-1 acquires audio information from an audio uttered by a user U.

In Step S616, the second device 200-1 creates an output signal including the information indicating a gaze position, the POI information, and the audio information acquired when the POI information has been acquired and transmits the output signal to the second device 200-2.

In Step S618, the presentation part 277 of the second device 200-2 displays the icon and the POI information on the mobile object image display device 250 based on the output signal from the second device 200-1 and outputs the audio from the second speaker 240 based on the audio information. For example, the presentation part 277 of the second device 200-2 acquires the output signal from the second device 200-1 from the second communication device 210 and acquires the position information, the POI information, and the audio information included in the acquired output signal. The presentation part 277 of the second device 200-2 presents the icon and the POI information to the image A presented on the mobile object image display device 250 based on the acquired position information and outputs the audio from the second speaker 240 based on the audio information.

FIG. 16 is a diagram showing an example of provided information. A user U performs a button pressing operation or a gesture input with a focus on an arbitrary position by operating the HMI 260 when a video is displayed on the mobile object image display device 250. The user U may perform the button pressing operation or the gesture input while gazing at a predetermined position included in the video displayed on the mobile object image display device 250. The line-of-sight detection part 280 detects a line-of-sight direction of the user U and acquires information of the predetermined position. The line-of-sight detection part 280 may convert the information of the predetermined position to three-dimensional position information based on the acquired information of the predetermined position, map data, and the position information of the mobile object M. In this case, the creation part 281 creates an output signal including the three-dimensional position information instead of the information of the predetermined position. In the example shown in FIG. 16, an icon IC27 is displayed on the Tokyo Tower TT at which the user U gazes, and “Tokyo Tower has been liked” is displayed as a comment on the POI information along with the POI information.

### Conclusion

The information processing system 1 having the aforementioned configuration includes a first device 100 mounted in a mobile object M, a plurality of second devices 200 used by a plurality of users U at places other than the mobile object M, an information acquisition part 315 configured to acquire predetermined information transmitted by the first device 100, a provision part 330 configured to provide the predetermined information acquired by the information acquisition part 315 to the plurality of second devices 200, and a plurality of presentation parts 277 configured to present the predetermined information provided to the plurality of second devices 200 by the provision part 330. When an operation input from a first user U1 is performed using one second device 200 of the plurality of second devices 200, the presentation parts 277 of the second devices 200 other than the one second device 200 present an output result based on the operation input performed using the one second device 200.

Since what another user has an interest and what another user thinks about can be smoothly transmitted between the users of the second devices 200, it is possible to improve convenience. An example of the second devices 200 is a head-mounted display. Examples of the predetermined information may include video data, image data, vehicle position data, map data near a traveling position, polygon data obtained by creating the surrounding of the traveling position using a 3D model, and a video of an onboard camera or a mounted smartphone.

The information processing system 1 further includes a user information acquisition part 279 configured to acquire user information of the users of the second devices 200. The second device 200 used by the first user further includes a creation part 281 configured to create an output signal for presenting the output result based on the user information acquired by the user information acquisition part 279.

The second device can acquire the user information from information of another second device provided with information from the first device and thus can perform communication based on the acquired user information. Since the second devices 200 can transmit a signal without communicating with the first device (onboard equipment) side, it is possible to curb an unnecessary increase in process load. Here, the second device may present information via the first device 100 without acquiring information from another second device.

In the information processing system 1, each second device includes a line-of-sight detection part 280 configured to detect a line-of-sight direction of a user. The presentation part 277 presents the output result based on the line-of-sight direction of the user detected by the line-of-sight detection part 280.

By identifying a position at which the output result is presented based on a line of sight of the user, it is possible to improve a simple operation to a desired position and intuitiveness.

The line-of-sight detection part 280 accurately tracks a motion and a position of the head of the user U, for example, using a 6 degrees-of-freedom (DoF) sensor mounted on the second devices 200. A camera having a function of detecting a line of sight instead of the 6 DoF sensor or in addition to the 6 DoF sensor may be used. The presentation part 277 may identify a position based on the line-of-sight direction of the user detected by the line-of-sight detection part 280 and present the output result to the identified position. The presentation part 277 may identify a gazed display area based on the line-of-sight direction of the user detected by the line-of-sight detection part 280 and present the output result to the identified display area.

In the information processing system 1, each second device includes a POI acquisition part 284 configured to acquire POI information. The POI acquisition part 284 acquires POI information based on position information of the first device 100 when the presentation part 277 presents the output result. The presentation part 277 presents the POI information acquired by the POI acquisition part 284 along with the output result.

Since the POI information can be combined into visual feedback, it is possible to more appropriately provide information to a user and to improve user experience of the user. The POI information includes information associated with a place or an object visually interested by a user. The POI information includes a facility, a scenic area, and a featured area which are generally popular.

In the information processing system 1, each second device includes a POI acquisition part 284 configured to acquire POI information. The POI acquisition part 284 acquires POI information based on the line-of-sight direction of the user detected by the line-of-sight detection part 280. The presentation part 277 acquires a position at which the output result is to be presented based on the POI information acquired by the POI acquisition part 284.

Since POI information can be identified based on a line of sight of a user and an output result can be output to an appropriate position, it is possible to enhance accuracy and relevance.

In the information processing system 1, each second device includes a POI acquisition part 284 configured to acquire POI information and a selection part 285 configured to select POI information closest to the mobile object out of a plurality of pieces of POI information when the plurality of pieces of POI information are acquired by the POI acquisition part 284. The presentation part 277 presents the POI information selected by the selection part 285 to the plurality of second devices.

When there are a plurality of pieces of POI information, it is possible to provide information with highest relevance to a user and thus to prevent an excessive increase in the amount of information and to improve user experience of the user. The selection part 285 may display a POI selection part to provide an interface for allowing a user to select interested POI information.

In the information processing system 1, the presentation part 277 changes a position at which the output result is to be presented based on a speed of the mobile object.

Since dynamic visual effects can be provided by changing a presentation position of an output result based on the speed of the mobile object, it is possible to provide more realistic and attractive experience to the user.

The information processing system 1 further includes a mobile object behavior detection part 282 configured to detect right turn or left turn of the mobile object M. The presentation part 277 changes details of the output result to be presented when right turn or left turn of the mobile object M is detected by the mobile object behavior detection part 282 after the output result has been presented.

Since the user can be informed that there is an interested thing before right turn or left turn is performed by changing details of the output result to be presented when the mobile object M performs right turn or left turn, it is possible to improve convenience.

The information processing system 1 further includes a creation part 281 configured to create notification information including the output result to the first device based on the operation input performed on one second device out of the plurality of second devices when the operation input from a first user is performed using the one second device.

Since the first device can acquire notification information from the second devices, it is possible to notify of emotion of the first user based on the acquired notification information.

The information processing system 1 further includes an audio information acquisition part 286 configured to acquire audio information based on audio from a user. The presentation part 277 presents the output result based on the operation input and the audio information.

Since an audio can be combined into visual feedback, it is possible to more appropriately provide information to a user and to improve user experience of the user.

The information processing system 1 further includes an audio information acquisition part 286 configured to acquire audio information based on audio from a user. The presentation part 277 presents the POI information and the audio information acquired in association with the POI information by the audio information acquisition part 286 along with the output result.

Since the POI information and the audio can be combined into visual feedback, it is possible to more appropriately provide information to a user and to improve user experience of the user.

### Use Examples

The information processing system 1 is available in the following aspects.

(A) An aspect in which a passenger P and a user U have a relationship of family or friends and virtual drive is provided to the user U. The user U can make a conversation with the passenger P about scenes near the mobile object M while seeing an image.

(B) An aspect in which a passenger P is a general user and a user U is a provider of a route guidance service, a driving instruction service. The user U can perform route guidance at a place at which the user has difficulty understanding from a navigation device while seeing scenes near the mobile object M or which is not apparent from a map or can instruct a driving operation.

(C) An aspect in which a passenger P is a celebrity, a user U is a general user, and virtual drive based on commerce is provided to the user U. In this case, a plurality of users U may be simultaneously correlated with one passenger P, and transmission of an audio, for example, from the user U side may be set to be off. When the user U pays an additional fee, a conversation of a predetermined time with the passenger P may become possible.

While an embodiment of the present invention has been described above, the present invention is not limited to the embodiment and can be subjected to various modifications and substitutions without departing from the gist of the present invention. While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

### EXPLANATION OF REFERENCES

1 Information processing system
100 First device
110 First communication device
120 First microphone
125 External sensor
130 Camera unit
132 Indoor camera
134 Outdoor camera
140 First speaker
150 User display device
160 HMI
170 First controller
190 Control target equipment
200 Second device
210 Second communication device
220 Second microphone
230 Detection device
232 Direction-of-orientation detection device
234 Head position detection device
236 Motion sensor
238 Line-of-sight detection device
240 Second speaker
250 Mobile object image display device
260 HMI
270 Second controller
300 Management server
310 Communication device
315 Information acquisition part
320 Matching processing part
330, 330A Provision part
340 Fee management part
350 Storage part
M Mobile object

What is claimed is:

1. An information processing system comprising:
a first device mounted in a mobile object;
a plurality of second devices used by a plurality of users at places different from that of the mobile object;
an information acquisition part configured to acquire predetermined information transmitted by the first device;
a provision part configured to provide the predetermined information acquired by the information acquisition part to the plurality of second devices; and
a plurality of presentation parts configured to present the predetermined information provided to the plurality of second devices by the provision part,
wherein, when an operation input from a first user is performed using one second device among the plurality of second devices, the presentation parts of the second devices other than the one second device present an output result based on the operation input performed using the one second device.

2. The information processing system according to claim 1, further comprising a user information acquisition part configured to acquire user information of users of the second devices,
wherein the second device used by the first user further includes a creation part configured to create an output signal for presenting the output result based on the user information acquired by the user information acquisition part.

3. The information processing system according to claim 1, wherein each second device includes a line-of-sight detection part configured to detect a line-of-sight direction of a user, and
wherein the presentation part presents the output result based on the line-of-sight direction of the user detected by the line-of-sight detection part.

4. The information processing system according to claim 1, wherein each second device includes a POI acquisition part configured to acquire point of interest (POI) information,
wherein the POI acquisition part acquires POI information based on position information of the first device when the presentation part presents the output result, and
wherein the presentation part presents the POI information acquired by the POI acquisition part along with the output result.

5. The information processing system according to claim 3, wherein each second device includes a POI acquisition part configured to acquire point of interest (POI) information,
wherein the POI acquisition part acquires POI information based on the line-of-sight direction of the user detected by the line-of-sight detection part, and
wherein the presentation part acquires a position at which the output result is to be presented based on the POI information acquired by the POI acquisition part.

6. The information processing system according to claim 1, wherein each second device includes a POI acquisition part configured to acquire point of interest (POI) information and a selection part configured to select POI information closest to the mobile object among a plurality of pieces of POI information when the plurality of pieces of POI information are acquired by the POI acquisition part, and
wherein the presentation part presents the POI information selected by the selection part to the second devices other than the one second device.

7. The information processing system according to claim 1, wherein the presentation part changes a position at which the output result is to be presented based on a speed of the mobile object.

8. The information processing system according to claim 1, further comprising a mobile object behavior detection part configured to detect right turn or left turn of the mobile object,
wherein the presentation part changes details of the output result to be presented when right turn or left turn of the mobile object is detected by the mobile object behavior detection part after the output result has been presented.

9. The information processing system according to claim 1, further comprising a creation part configured to create notification information including the output result to the first device based on an operation input performed on one second device among the plurality of second devices when the operation input from a first user is performed using the one second device.

10. The information processing system according to claim 1, further comprising an audio information acquisition part configured to acquire audio information based on audio from a user,
wherein the presentation part presents the output result based on the operation input and the audio information.

11. The information processing system according to claim 4, further comprising an audio information acquisition part configured to acquire audio information based on audio from a user,
wherein the presentation part presents the POI information and the audio information acquired in association with the POI information by the audio information acquisition part along with the output result.
